(19) United States
(12) Patent Application Publication
(10) Pub. No.: US 2008/0215601 A1
(43) Pub. Date: Sep. 4, 2008

(54) SYSTEM MONITORING PROGRAM, SYSTEM MONITORING METHOD, AND SYSTEM MONITORING APPARATUS

(75) Inventor: Yukiko SEKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/038,563

(22) Filed: Feb. 27, 2008

(30) Foreign Application Priority Data
Mar. 1, 2007 (JP) 2007-51624

(51) Int. Cl. G06F 17/30

(52) U.S. Cl. 707/100

(57) ABSTRACT

A system monitoring apparatus, method and program determining whether each unit process executed by a system matches one of a plurality of unit process models generated by individually modeling a plurality of types of unit processes, determining whether an analysis of a processing status of the system is needed based on determining whether each unit process matches one of the plurality of unit process models, and displaying a difference of a most approximate unit process model among the plurality of unit process models in relation to each unit process determined as matching none of the plurality of unit process models.

### CROSS-REFERENCE TO RELATED APPLICATIONS

This application is related to and claims the benefit of priority from Japanese Patent Application No. 2007-51624, filed on Mar. 1, 2007, the entire contents of which are incorporated herein by reference.

### BACKGROUND

### Field

The present invention relates to system monitoring program(s), method(s), and apparatus(es) for monitoring a system in which a plurality of types of unit process(es) are executed. More specifically, the present invention relates to a system monitoring program, method, and apparatus implemented to aid monitoring of a system and/or execute analysis of a processing status of a system.

### SUMMARY

The disclosed system monitoring apparatus and method monitor a system in which a plurality of types of unit processes are executed.

The system monitoring apparatus and method include determining whether each unit process executed by a system matches one of a plurality of unit process models generated by individually modeling a plurality of types of unit processes, determining, based on a result of determination of whether each unit process matches one of the process models, whether analysis of a processing status of the system is needed, and displaying, when determining that analysis of the processing status of the system is needed, a difference of a most approximate unit process model among the plurality of unit process models in relation each unit process determined as matching none of the plurality of unit process models.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating a scheme of transaction monitoring and detailed analysis;

FIG. 2 is a functional block diagram illustrating a configuration of a transaction monitoring apparatus;

FIG. 3 is a diagram illustrating an example of new transaction information stored in a new-transaction-information storage unit;

FIG. 4 is a diagram illustrating a transaction notation;

FIG. 5 is a diagram illustrating an example of monitoring setting information stored in a monitoring-setting-information storage unit;

FIG. 6 is a diagram illustrating an example of model information stored in a model-information storage unit;

FIG. 7 is a diagram illustrating an example of transaction element dissimilarities stored in a transaction-element-dissimilarity storage unit;

FIG. 8 is a diagram illustrating an example of analysis-result transaction information stored in an analysis-result-transaction-information storage unit;

FIG. 9 is a diagram illustrating an example of monitoring information stored in a monitoring-information storage unit;

FIG. 10 is a diagram illustrating a matching process executed by a transaction-and-model matching unit;

FIG. 11 is a diagram illustrating an example of a monitoring screen displayed by a monitoring-information displaying unit;

FIG. 12 is a flowchart illustrating a procedure of a transaction monitoring process executed by a transaction monitoring apparatus;

FIG. 13A is a first diagram illustrating a detailed analysis executed by a transaction detail analyzing apparatus;

FIG. 13B is a second diagram illustrating a detailed analysis executed by a transaction detail analyzing apparatus;

FIG. 14 is a functional block diagram illustrating a configuration of a transaction detail analyzing apparatus;

FIG. 15 is a diagram illustrating an example of detailed-analysis setting information stored in a detailed-analysis-setting-information storage unit;

FIG. 16 is a diagram illustrating an example of analysis-result transaction information stored in an analysis-result-transaction-information storage unit;

FIG. 17 is a diagram illustrating an example of performance degradation/problem patterns stored in a performance degradation/problem pattern DB;

FIG. 18 is a diagram illustrating an example of updating of the model information shown in FIG. 6;

FIG. 19 is a diagram illustrating an example of updating of the performance degradation/problem patterns shown in FIG. 17;

FIG. 20 is a diagram illustrating an example of updating of the analysis-result transaction information shown in FIG. 16;

FIG. 21 is a flowchart illustrating a procedure of a transaction detail analyzing process executed by a transaction detail analyzing apparatus;

FIG. 22 is a diagram illustrating an example of problem records displayed on a group-by-group basis; and

FIG. 23 is a functional block diagram illustrating a configuration of a computer that executes a transaction monitoring program.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Computer systems play a role of indispensable infrastructure systems in various fields, as a result, it is becoming increasingly important to keep computer systems running consistently and properly without stopping. Thus, various techniques for monitoring an operation status of computer systems and discovering abnormalities in the systems as soon as possible are needed.

For example, in the case of a network system, techniques for determining a range relevant to a symptom of a problem by linking network system design information, such as site information and network configuration information, to operation statistics information of network devices and displaying a list of operation statistics information of network devices along a path from a server to a client have been developed (e.g., Japanese Unexamined Patent Application Publication No. 2002-99469).

In the case of a business system, in order to monitor a processing status, it is effective to analyze transactions (flow of service processes) that serve as unit processes. Thus, techniques for collecting a log of messages exchanged for service processes on a network and estimating transactions on the basis of calling relationships among the messages in the log have been developed (e.g., Japanese Unexamined Patent Application Publication No. 2006-11683). By using such techniques, it is possible to extract a large number of types of transactions in the business system, even those with low frequencies of occurrence, without manual operations. This can aid analysis of the system.

Now, a system monitoring program, method, and apparatus according to a preferred embodiment of the present invention is described with reference to the accompanying drawings.

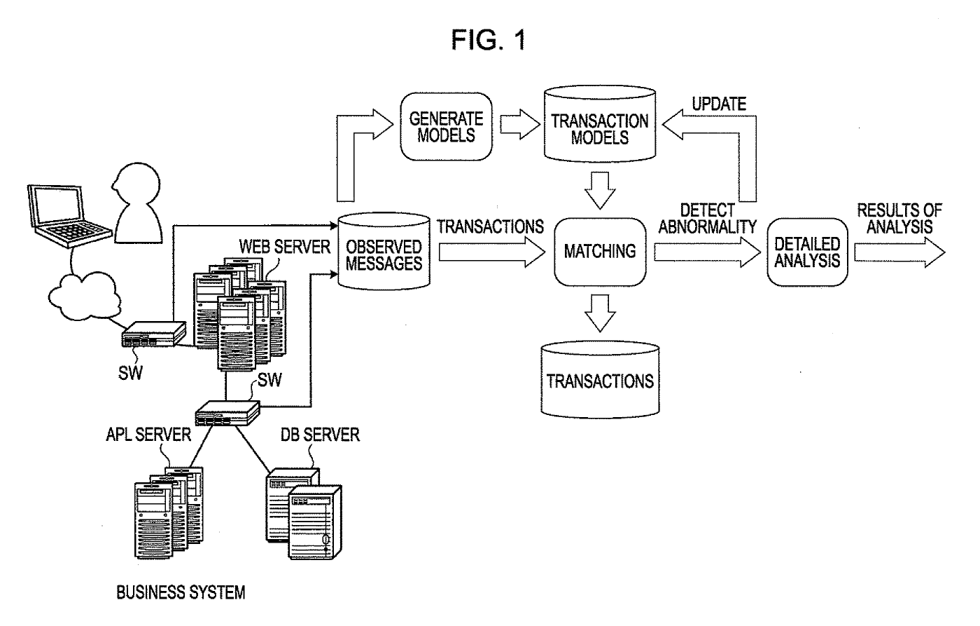

First, a scheme of transaction monitoring and detailed analysis according to an embodiment is described. FIG. 1 is an example of a diagram explaining the scheme of transaction monitoring and detailed analysis according to this embodiment. As shown in FIG. 1, in the transaction monitoring according to this embodiment, message(s) exchanged in a business system including a Web server, an application server (APL server), and a database server (DB server) are observed, and transaction(s) are extracted from the observed messages.

Furthermore, a matching process is performed to find a match between the extracted transactions and transaction models, and a processing status of the business system is monitored on the basis of a ratio of transactions for which matching transaction models have been found. If an abnormality in the business system is detected, transactions for which no matching transaction models have been found are analyzed in detail, and results of the analysis are displayed. The transaction models are generated by modeling individual types of transactions on the basis of previous transactions that were extracted from observed messages.

Furthermore, in the transaction monitoring according to this embodiment, the transaction models are updated when an update instruction issued by a system administrator is received. The system administrator issues an instruction for updating the transaction models when it is determined on the basis of displayed result(s) of analysis that mismatch with the transaction models is caused by updating of the system or change in usage patterns of the system necessitating updating of the transaction models.

Hereinafter, a case where a transaction monitoring apparatus monitors a business system and a transaction detail analyzing apparatus performs detailed analysis of transaction(s) is described. Alternatively, however, monitoring of a business system and detailed analysis of transactions may both be performed by a single apparatus.

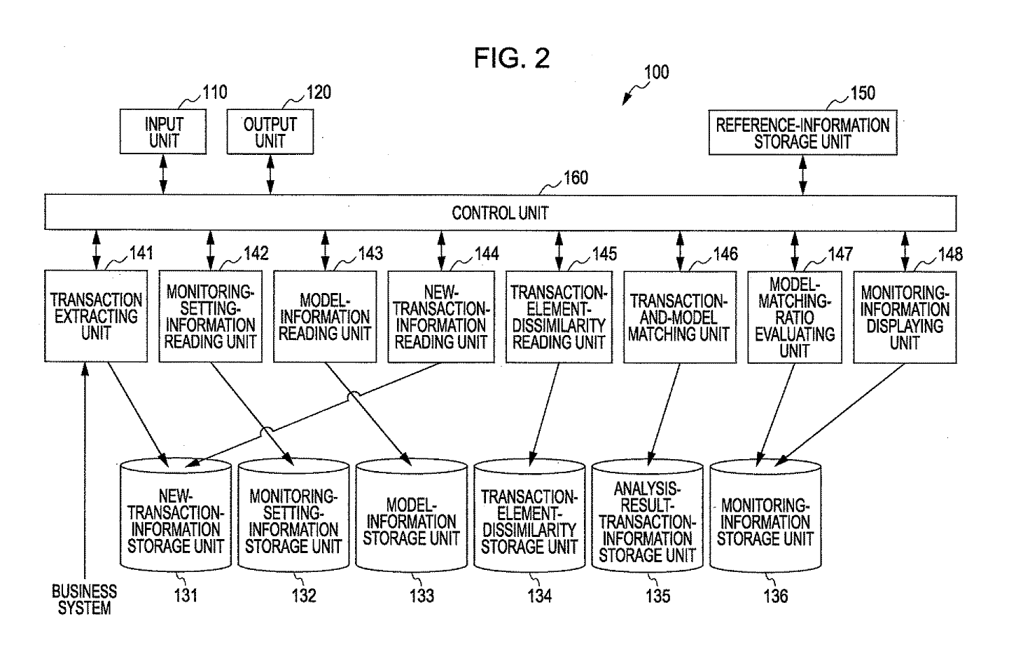

Next, a configuration of a transaction monitoring apparatus according to an embodiment is described. FIG. 2 is one example of a functional block diagram showing a configuration of the transaction monitoring apparatus according to this embodiment. As shown in FIG. 2, a transaction monitoring apparatus 100 includes an input unit 110, an output unit 120, a new-transaction-information storage unit 131, a monitoring-setting-information storage unit 132, a model-information storage unit 133, a transaction-element-dissimilarity storage unit 134, an analysis-result-transaction-information storage unit 135, and a monitoring-information storage unit 136. As also shown in FIG. 2, the transaction monitoring apparatus includes a transaction extracting unit 141, a monitoring-setting-information reading unit 142, a model-information reading unit 143, a new-transaction-information reading unit 144, a transaction-element-dissimilarity reading unit 145, a transaction-and-model matching unit 146, a model-matching-ratio evaluating unit 147, a monitoring-information displaying unit 148, a reference-information storage unit 150, and a controlling unit 160.

The input unit 110 is a processing unit that accepts (receives) various instructions regarding monitoring of transaction(s), for example, from a system administrator. More specifically, the input unit 110 accepts (receives) instruction(s) issued by the system administrator using an input device, such as a mouse, a keyboard, etc. The output unit 120 is a processing unit that outputs result(s) of monitoring by the transaction monitoring apparatus 100. For example, the output unit 120 outputs result(s) of monitoring to an output device, such as a display.

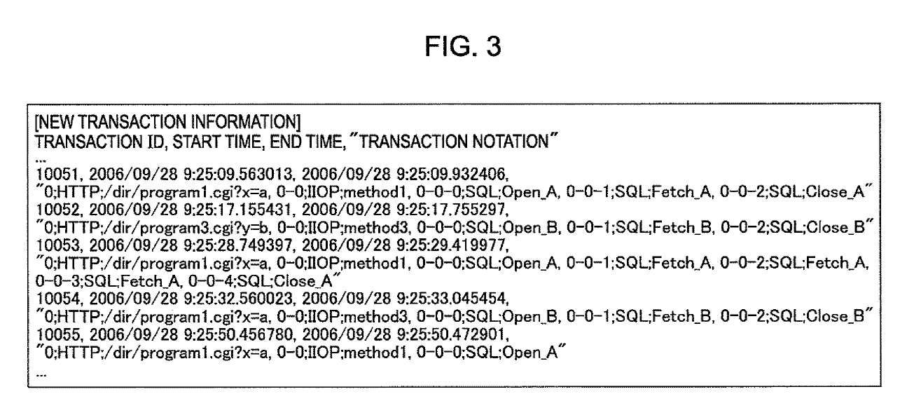

The new-transaction-information storage unit 131 is a storage unit that stores information regarding new transactions that are monitored, as new transaction information. FIG. 3 is a diagram showing an example of new transaction information stored in the new-transaction-information storage unit 131. As shown in FIG. 3, for each transaction, the new-transaction-information storage unit 131 stores a transaction ID identifying the transaction, a start time and end time of the transaction, and a “transaction notation” (for example, a character string representing a transaction notation, enclosed by quotation marks), as new transaction information.

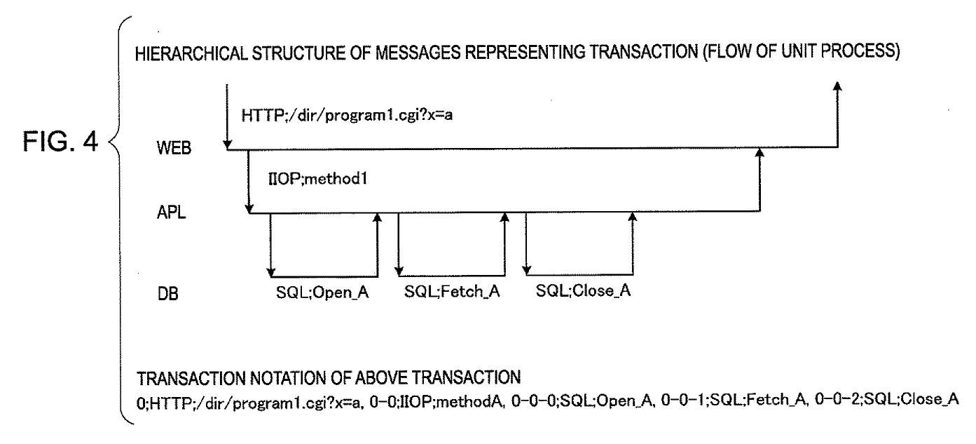

A transaction notation represents a hierarchical structure of a plurality of messages constituting a transaction. FIG. 4 is diagram explaining a transaction notation. As shown in FIG. 4, a transaction has a hierarchical structure composed of three layers, namely, “layer 0” as a Web server layer, “layer 1” as an application server layer, and “layer 2” as a database server layer.

For example, in a transaction “M1”, a message “HTTP;/dir/program1.cgi?x=a” in “layer 0” is first executed, a message “IIOP;method1” in “layer 1” is executed next, messages in “layer 2” are then executed, and then the processing returns to “layer 1”.

In “layer 2”, a message “SQL;Open_A”, a message “SQL;Fetch_A”, and a message “SQL;Close_A” are executed, and after all these messages have been executed, the processing returns to “layer 1” and then to “layer 0”, whereby all the processing is completed. When all the processing has been completed, results of the processing in the transaction are returned, whereby the transaction is completed.

Thus, in a transaction notation, a transaction is represented with a notation indicating a layer before each message, such as “0”, “0-0”, or “0-0-1”. “0” indicates a first message in “layer 0”, “0-0” indicates a first message in “layer 1”, and “0-0-1” indicates a second message in “layer 2”.

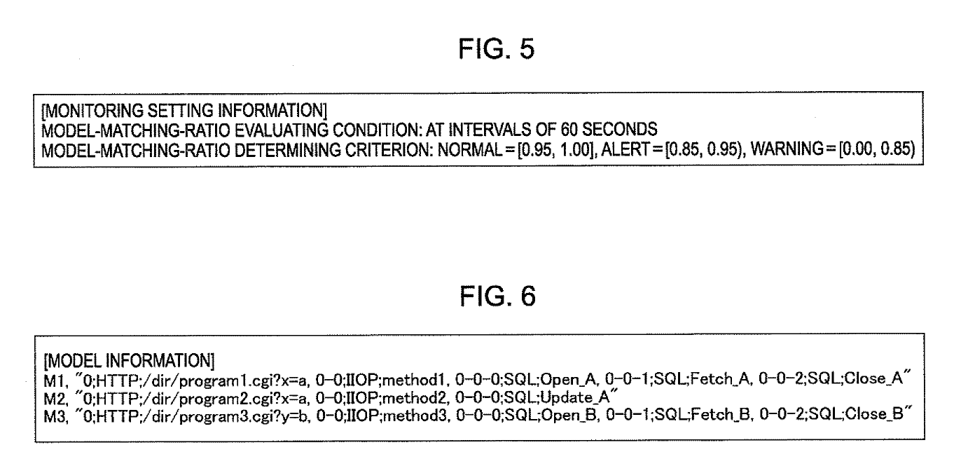

The monitoring-setting-information storage unit 132 is a storage unit that stores setting information regarding system monitoring, as monitoring setting information. FIG. 5 is a diagram showing an example of monitoring setting information stored in the monitoring-setting-information storage unit 132. As shown in FIG. 5, the monitoring-setting-information storage unit 132 stores a model-matching-ratio evaluating condition and a model-matching-ratio determining criterion as monitoring setting information.

The model-matching-ratio evaluating condition defines an interval of time at which a ratio of matching between new transactions and transaction models is evaluated. Furthermore, the model-matching-ratio determining criterion serves to determine a processing status of the system on the basis of the model matching ratio. In this example, the transaction monitoring apparatus 100 determines that a processing status of the system is “normal” if the model matching ratio is greater than or equal to 0.95 and less than or equal to 1.00, determines that the processing status of the system is “alert” if the model matching ratio is greater than or equal to 0.85 and less than 0.95, and determines that the processing status of the system is “warning” if the model matching ratio is greater than or equal to 0.00 and less than 0.85.

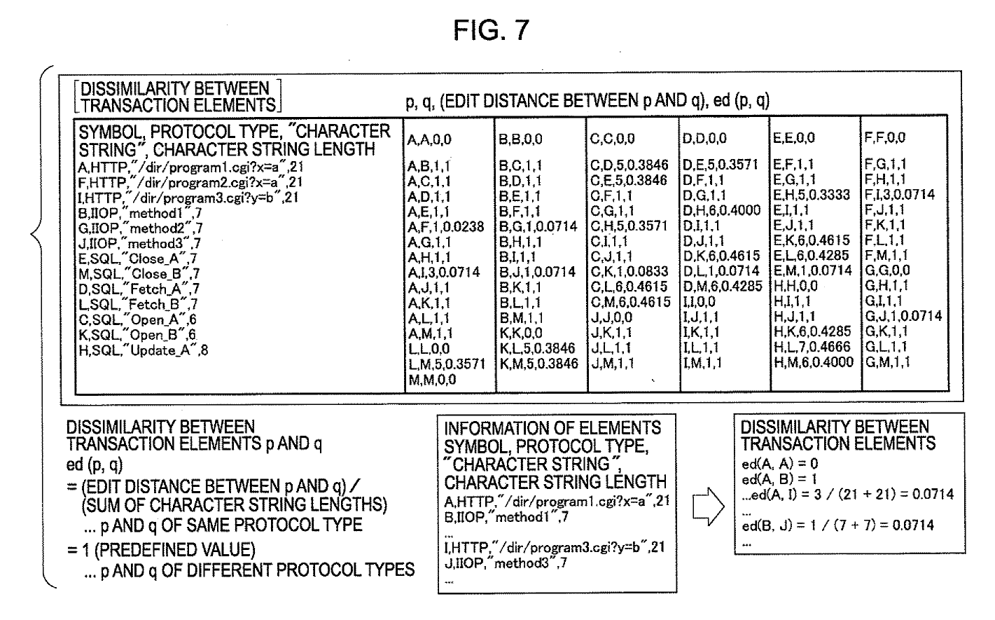

The model-information storage unit 133 is a storage unit that stores information of transaction models as model information. FIG. 6 is a diagram showing an example of model information stored in the model-information storage unit 133. As shown in FIG. 6, as model information, for each transaction model, the model-information storage unit 133 stores a model ID identifying the transaction model, such as “M1” or “M2”, and a “transaction notation”, in association with each other.

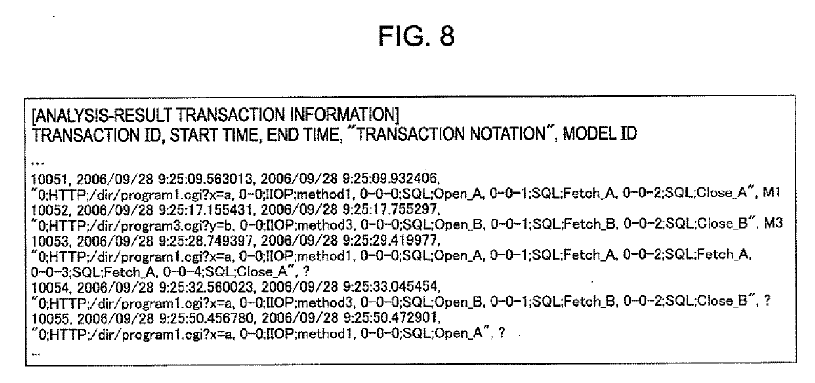

The transaction-element-dissimilarity storage unit 134 is a storage unit that stores transaction element dissimilarities, i.e., dissimilarities between transaction elements. FIG. 7 is a diagram showing an example of transaction element dissimilarities stored in the transaction-element-dissimilarity storage unit 134. As shown in FIG. 7, for each transaction element, the transaction-element-dissimilarity storage unit 134 stores, in association with a symbol identifying a transaction element, a protocol type of the transaction element, such as “HTTP” or “IIOP”, a “character string” including the transaction element other than the protocol type, and a character string length. Furthermore, for each pair of transaction elements, the transaction-element-dissimilarity storage unit 134 stores an edit distance and dissimilarity information between the transaction elements.

The edit distance between transaction elements p and q refers to a number of times of insertion, deletion, or replacement that is needed to obtain the transaction element q from the transaction element p. When the transactions p and q are of the same protocol type, the dissimilarity ed(p, q) between the transaction elements p and q is defined as follows:

ed(p,q)=(Edit distance between p and q)/(Sum of character string lengths of p and q)

Whereas when the transaction elements p and q are of different protocol types the dissimilarity ed(p, q) is defined as follows:

ed(p,q)=1(predefined value)

For example, in FIG. 7, a transaction element A and a transaction element I are of the same protocol type. The edit distance between the transaction elements A and I is 3, i.e., the character string “/dir/program3.cgi?y=b” of the transaction element I can be obtained by performing character insertion, deletion, or replacement on the character string “/dir/program1.cgi?x=a” of the transaction element A. Furthermore, since the character string length of the transaction element A is “21” and the character string length of the transaction element I is “21”, the dissimilarity ed(A, I) between these transaction elements A and I can be calculated as follows:

ed(A,I)=3/(21+21)=0.0714

On the other hand, the transaction element A and the transaction element B are of different protocol types, so that the dissimilarity ed(A, B) between the transaction elements A and B takes on a predefined value as follows:

ed(A,B)=1

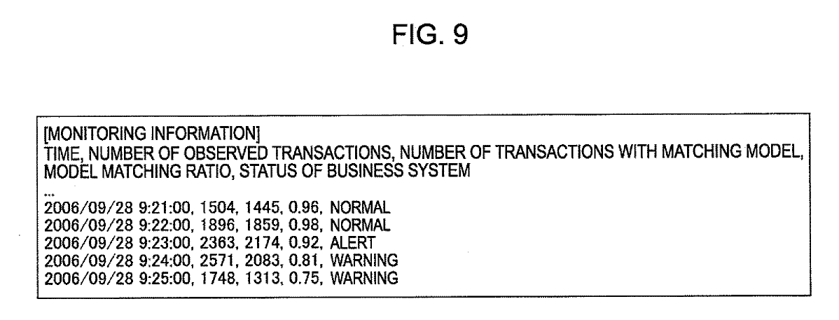

The analysis-result-transaction-information storage unit 135 is a storage unit that stores results of analysis of new transactions as analysis-result transaction information. FIG. 8 is a diagram showing an example of analysis-result transaction information stored in the analysis-result-transaction-information storage unit 135. As shown in FIG. 8, as analysis-result transaction information, the analysis-result-transaction-information storage unit 135 stores information including new transaction information and model IDs added as analysis results. The model IDs in the information are model IDs of transaction models matching the new transactions.

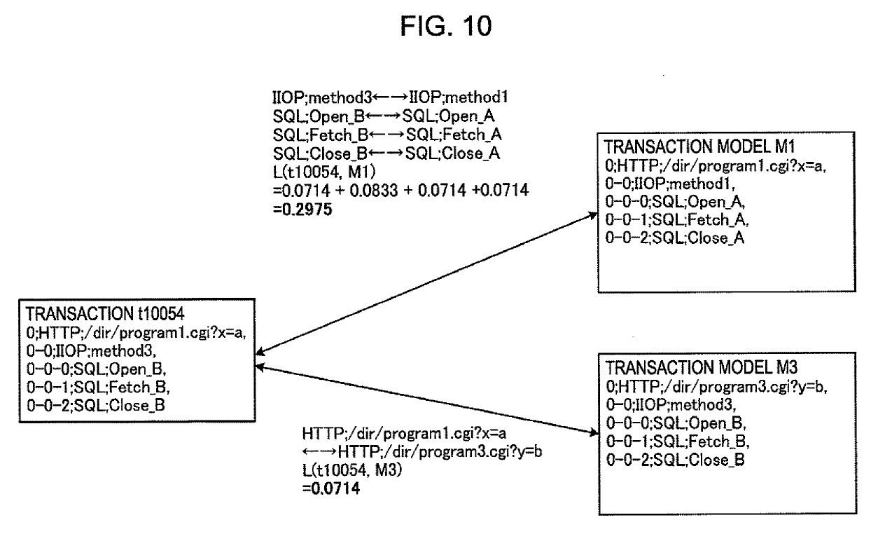

The monitoring-information storage unit 136 is a storage unit that stores results of monitoring of a processing status of a business system as monitoring information. FIG. 9 is a diagram showing an example of monitoring information stored in the monitoring-information storage unit 136. As shown in FIG. 9, as monitoring information, the monitoring-information storage unit 136 stores results of monitoring of a business system, including information pertaining to a timer a number of observed transactions representing a number of processed transactions, a model matching number representing a number of transactions with a matching model, a model matching ratio, and a status of the business system, at intervals of 60 seconds.

The 60 seconds here is a value defined as a model-matching-ratio evaluating condition, and the status of the business system is determined on the basis of a model-matching-ratio determining criterion. However, the present invention is not limited to any particular value as a as a model-matching-ratio evaluating condition. For example, the model-matching-ratio evaluating condition and the model-matching-ratio determining criterion are values defined by a system administrator as monitoring setting information and stored in the monitoring-setting-information storage unit 132.

The transaction extracting unit 141 is a processing unit that collects a log of messages exchanged for transaction processing on a network, and extracts transactions on the basis of calling relationship(s) among the messages in the log. Information regarding the transactions extracted by the transaction extracting unit 141 is stored in the new-transaction-information storage unit 131. Although the transaction extracting unit 141 is provided in the transaction monitoring apparatus 100 herein, the transaction extracting unit 141 may be provided as a separate apparatus.

The monitoring-setting-information reading unit 142 is a processing unit that reads monitoring setting information from the monitoring-setting-information storage unit 132 and writes the monitoring information to the reference-information storage unit 150. The model-information reading unit 143 is a processing unit that reads model information from the model-information storage unit 133 and writes the model information to the reference-information storage unit 150.

The new-transaction-information reading unit 144 is a processing unit that reads information of new transactions from the new-transaction-information storage unit 131 and supplies the information to the transaction-and-model matching unit 146 on a transaction-by-transaction basis. The transaction-element-dissimilarity reading unit 145 is a processing unit that reads transaction element dissimilarities from the transaction-element-dissimilarity storage unit 134 and writes the transaction-element dissimilarities to the reference-information storage unit 150.

The transaction-and-model matching unit 146 is a processing unit that receives information of new transactions from the new-transaction-information reading unit 144 on a transaction-by-transaction basis, and that executes a matching process to determine whether each of the new transactions matches one of the transaction models with reference to the model information and the transaction-element dissimilarities stored in the reference-information storage unit 150. The transaction-and-model matching unit 146 then writes the results to the analysis-result-transaction-information storage unit 135 as information attached to information of the transactions.

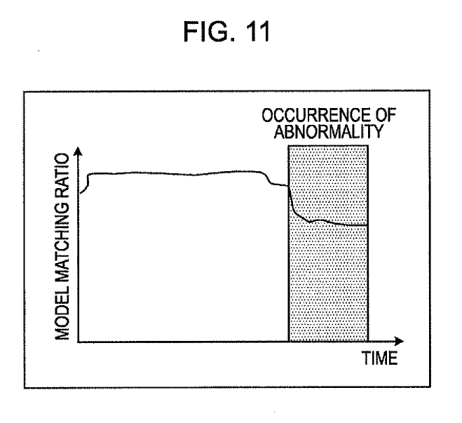

FIG. 10 is a diagram explaining a matching process executed by the transaction-and-model matching unit 146. FIG. 10 shows a matching process executed by the transaction-and-model matching unit 146 regarding a new transaction “t10054” and transaction models “M1” and “M3”.

The transaction-and-model matching unit 146 calculates a distance L(ti, Mj) between a transaction ti and each transaction model Mj using a relevant transaction element dissimilarity, and determines that the transaction ti matches a transaction model Mk if L(ti, Mk) is smallest and is within a predetermined threshold.

For example, since “HTTP;/dir/program1/cgi?x=a” of “t10054” and “HTTP;/dir/program1/cgi?x=a” of “M1” are the same, the transaction element dissimilarity is 0. Furthermore, the transaction element dissimilarity between “IIOP;method3” of “t10054” and “IIOP;method1” of “M1” is 0.0714 according to FIG. 7, and the transaction element dissimilarity between “SQL;Open_B” of “t10054” and “SQL;Open_A” of “M1” is 0.0833 according to FIG. 7. Furthermore, the transaction element dissimilarity between “SQL;Fetch_B” of “t10054” and “SQL;Fetch_A” of “M1” is 0.0714 according to FIG. 7, and the transaction element dissimilarity between “SQL;Close_B” of “t10054” and “SQL;Close_A” of “M1” is 0.0714 according to FIG. 7. Thus, L(t10054, M1)=0+0.0714+0.0833+0.0714+0.0714=0.2975.

Similarly, L(t10054, M3)=0.0714, so the transaction-and-model matching unit 146 determines that a distance between “t10054” and “M3” is smallest. Then, the transaction-and-model matching unit 146 compares a value of L(t10054, M3) with the predetermined threshold The transaction-and-model matching unit 146 determines that “t10054” matches “M3” if the value of L(t10054, M3) is within the predetermined threshold, and determines that “t10054” does not match any transaction model if the value of L(t10054, M3) is not within the predetermined threshold.

As described above, the transaction-and-model matching unit 146 calculates the distance L(ti, Mj) between the transaction ti and each transaction model Mj using the relevant transaction element dissimilarity, and determines that the transaction model ti matches the transaction model Mk if the smallest distance L(ti, Mk) is within the predetermined threshold. In this manner, the transaction-and-model matching unit 146 can determine whether each new transaction matches one of the transaction models. Furthermore, the transaction-and-model matching unit 146 counts number of transaction(s) for which the matching process has been executed and number of matching transaction(s).

The model-matching-ratio evaluating unit 147 is a processing unit that calculates model matching ratios at intervals of time defined by the model-matching-ratio evaluating condition, and that determines the processing status of the business system on the basis of the model-matching-ratio determining criterion. The model-matching-ratio evaluating unit 147 supplies the determined status to the monitoring-information storage unit 136 as monitoring information.

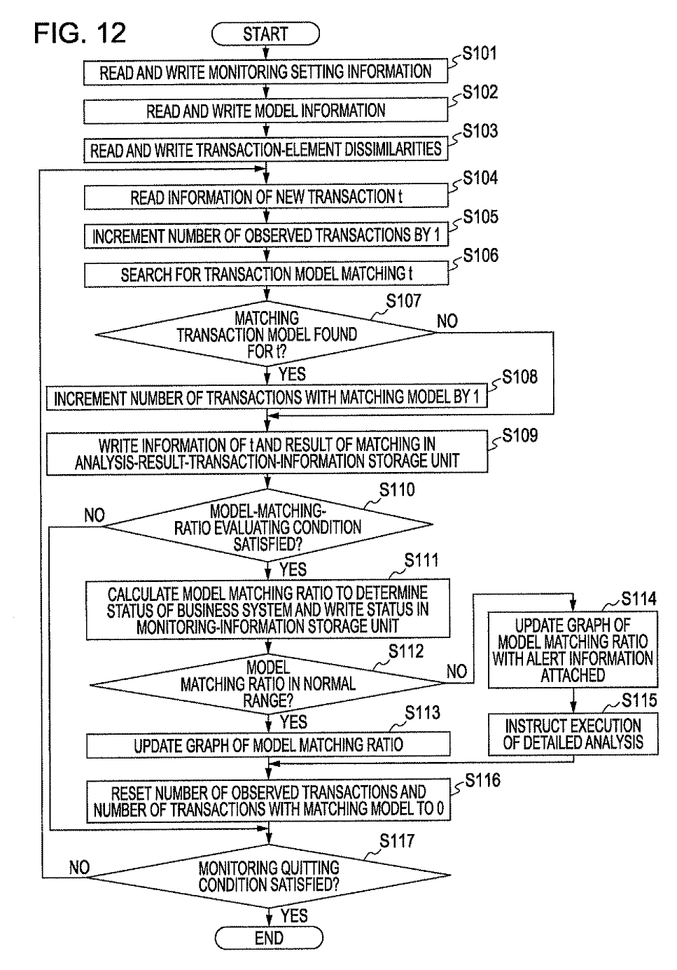

The monitoring-information displaying unit 148 is a processing unit that displays monitoring information stored in the monitoring-information storage unit 136 via the output unit 120. FIG. 11 is a diagram showing an example of a monitoring screen displayed by the monitoring-information displaying unit 148. As shown in FIG. 11, in a monitoring screen, model matching ratios are displayed at intervals defined by the model-matching-ratio evaluating condition, and alert information is attached in periods when a processing status of the business system is determined by the model-matching-ratio evaluating unit 147 as not “normal” (occurrence of abnormality).

The reference-information storage unit 150 is a storage unit that stores monitoring setting information, model information, new transaction information, and transaction element dissimilarities read by the monitoring-setting-information reading unit 142, the model-information reading unit 143, the new-transaction-information reading unit 144, and the transaction-element-dissimilarity reading unit 145, respectively. The information stored in the reference-information storage unit 150 is referred to by the transaction-and-model matching unit 146 and the model-matching-ratio evaluating unit 147.

The controlling unit 160 controls the input unit 110, the output unit 120, the transaction extracting unit 141, the monitoring-setting-information reading unit 142, the model-information reading unit 143, the new-transaction-information reading unit 144, the transaction-element-dissimilarity reading unit 145, the transaction-and-model matching unit 146, the model-matching-ratio evaluating unit 147, and the monitoring-information displaying unit 148 so that the transaction monitoring apparatus 100 functions as one apparatus. The storage units shown in FIG. 2 may be provided in a magnetic disk device, and arrows between the storage units and processing units represent accesses from processing unit(s) to storage unit(s).

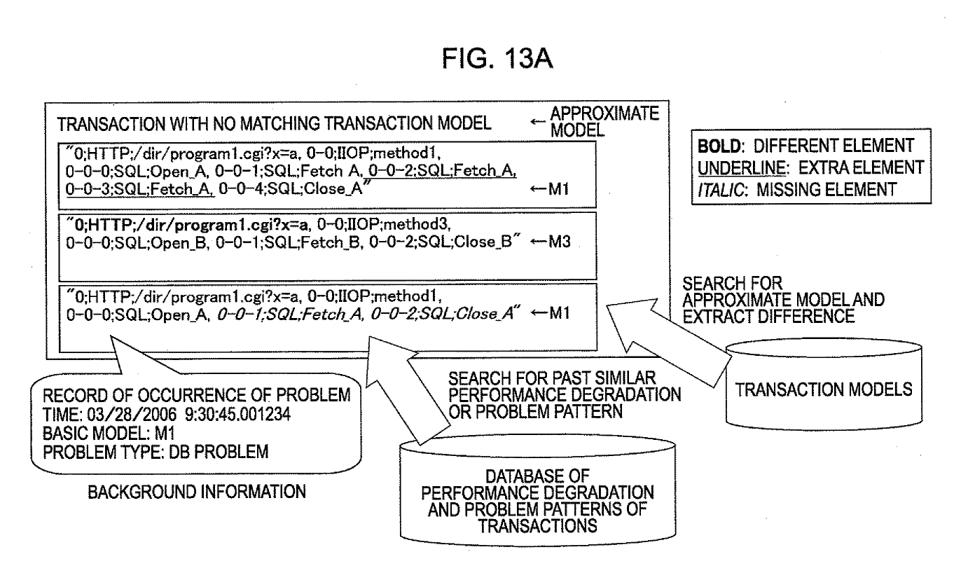

Next, a procedure of a transaction monitoring process executed by the transaction monitoring apparatus 100 according to an embodiment is described. FIG. 12 is a flowchart showing the procedure of the transaction monitoring process executed by the transaction monitoring apparatus 100 according to this embodiment.

As shown in FIG. 12, in a transaction monitoring process, the monitoring-setting-information reading unit 142 reads monitoring setting information and writes the monitoring setting information to the reference-information storage unit 150 (operation S101). Furthermore, the model-information reading unit 143 reads model information and writes the model information to the reference-information storage unit 150 (operation S102). Furthermore, the transaction-element dissimilarity reading unit 145 reads transaction element dissimilarities and writes the transaction element dissimilarities to the reference-information storage unit 150 (operation S103).

Then, the new-transaction-information reading unit 144 reads information of a new transaction t and passes information of the transaction t to the transaction-and-model matching unit 146 (operation S104), and the transaction-and-model matching unit 146 adds “1” to the number of observed transactions (increments number of observed transaction(s) by 1) (operation S105). It is assumed here that a number of observed transactions has been initialized to “0”.

Then, the transaction-and-model matching unit 146 searches the reference-information storage unit 150 for a transaction model that matches the transaction t (operation S106), and determines whether a transaction model that matches the transaction t exists (operation S107). If a transaction model that matches the transaction t exists, the transaction-and-model matching unit 146 adds “1” to the model matching number (operation S108) (increments number of transaction(s) with matching model by 1). It is assumed here that the model matching number has been initialized to “0”. On the other hand, if at operation S107, it is determined that a transaction model that matches the transaction t does not exist, the process proceeds to operation S109 discussed in detail below.

Then, the transaction-and-model matching unit 146 writes information of the transaction t and the result of matching in the analysis-result-transaction-information storage unit 135 (operation S109). Then, with reference to the model-matching-ratio evaluating condition in the reference-information storage unit 150, the model-matching-ratio evaluating unit 147 checks whether a model-matching-ratio evaluating condition is satisfied, i.e., whether a time to evaluate a model matching ratio has occurred (operation S110). If the model-matching-ratio evaluating condition is not satisfied, the process proceeds to operation S117.

On the other hand, if the model-matching-ratio evaluating condition is satisfied, the model-matching-ratio evaluating unit 147 calculates a model matching ratio using a number of observed transactions and a number of models with matching model. Then, the model-matching-ratio evaluating unit 147 determines a status of the business system according to the model matching ratio on the basis of the model-matching-ratio determining criterion, and writes the status to the monitoring-information storage unit 136 (operation S111).

Then, the monitoring-information displaying unit 148 checks whether the model matching ratio written to the monitoring-information storage unit 136 is within a normal range (operation S112). If the model matching ratio is within the normal range, the monitoring-information displaying unit 148 updates a display of a graph of model matching ratio (operation S113). If the model matching ratio is not within the normal range, the monitoring-information displaying unit 148 updates display of the graph of model matching ratio with alert information attached (operation S114). Furthermore, the controlling unit 160 instructs the transaction detail analyzing apparatus to execute detailed analysis (operation S115).

The controlling unit 160 initializes the number of observed transactions and the model matching number to “0” (operation S116), and checks whether a predetermined monitoring quitting condition is satisfied (operation S117). If the predetermined monitoring quitting condition is not satisfied, the process returns to operation S104 to process a next transaction. On the other hand, if the predetermined monitoring quitting condition is satisfied, the transaction monitoring process is exited.

As described above, a detailed analysis can be started by instructing the transaction detail analyzing apparatus to execute detailed analysis when a model matching ratio is not within the normal range.

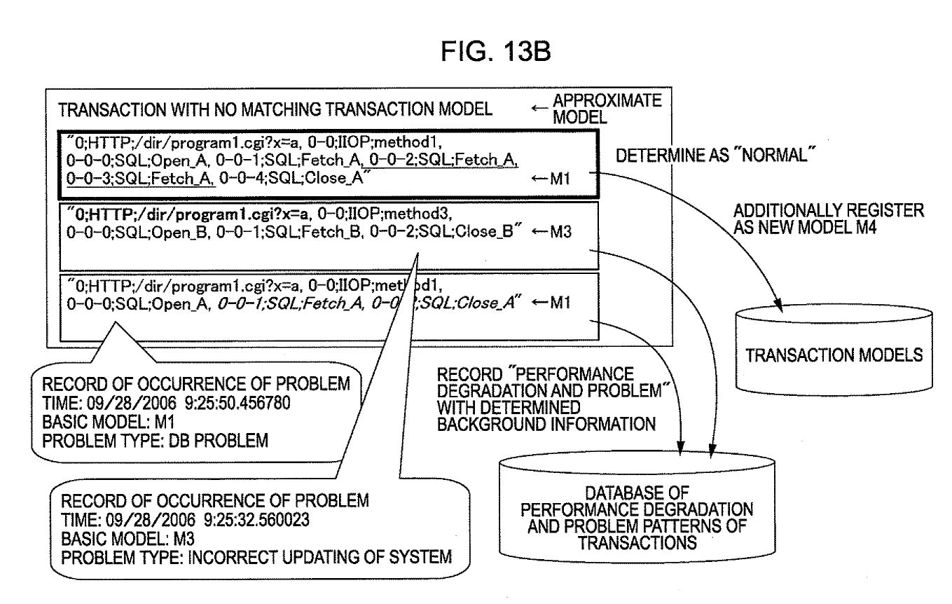

Next, detailed analysis executed by the transaction detail analyzing apparatus is described. FIGS. 13A and 13B are diagrams explaining detailed analysis executed by the transaction detail analyzing apparatus.

As shown in FIG. 13A, for each transaction not matching any transaction model, the transaction detail analyzing apparatus identifies a most approximate transaction model (a transaction model highly similar to a transaction in comparison to other transaction models) as an approximate model, and extracts a difference from the approximate model.

Then, the transaction detail analyzing apparatus displays the transaction in such a manner that the extracted difference is highlighted. For example, the transaction detail analyzing apparatus displays a transaction element different from that in the approximate model in bold letters, a transaction element not existing in the approximate model with an underline, and an element existing in the approximate model but missing in the transaction in italics. Although specific types of indicating (i.e., presenting in bold, underline, italic, etc.) a difference between a transaction and a most approximate transaction model is discussed in relation to FIG. 13A, the present invention is not limited to any particular type of indicating a difference.

With the output from the apparatus according to this embodiment described above, advantageously, the system administrator can readily grasp a change in a processing status of a system, so that the system administrator can readily analyze the processing status of the system.

Furthermore, the transaction detail analyzing apparatus stores information regarding problem instance(s) of transaction(s) that occurred in the past as performance degradation/problem pattern(s) in a database. If a similar performance degradation/problem pattern exists in the database, the transaction detail analyzing apparatus displays a time of occurrence, a problem type, a basic model (approximate model), and so forth of the performance degradation/problem pattern as background information.

As shown in FIG. 13B, if the system administrator determines on the basis of the displayed results of transaction analysis that the transaction is a normal transaction relating to updating of the system or the like, the transaction detail analyzing apparatus accepts a determination that the transaction is “normal” from the system administrator, and additionally registers the transaction as a new transaction model.

On the other hand, if an input indicating that system administrator has determined that the transaction is caused by a performance degradation, a problem, or the like of the system, the transaction analyzing apparatus additionally registers the transaction in the transaction performance degradation/problem database together with the background information.

As described above, the transaction detail analyzing apparatus displays transactions in such a manner that differences from approximate models are highlighted, and if a similar performance degradation/problem pattern in the past is found, the transaction detail analyzing apparatus displays background information of the performance degradation/problem pattern. This can aid analysis of a processing status of a system by the system administrator.

That is, with the output from the apparatus according to the embodiment described above, the system administrator can efficiently obtain past information regarding occurrence of problem(s) in the system. Thus, advantageously, the system administrator can efficiently analyze the processing status of the system.

Furthermore, the transaction detail analyzing apparatus additionally registers a transaction for which a determination by the system administrator that the transaction is “normal” is accepted as a new transaction model. Thus, transaction models can be updated in accordance with updating of the system or change in usage pattern(s) of the system. Furthermore, the transaction detail analyzing apparatus additionally registers performance degradation/problem patterns of transactions in the database, so that the database becomes more effective.

That is, in the apparatus according to this embodiment, transaction models are updated in accordance with updating of the system or change in usage pattern(s) of the system. Thus, advantageously, the load of a system administrator to update transaction models can be alleviated.

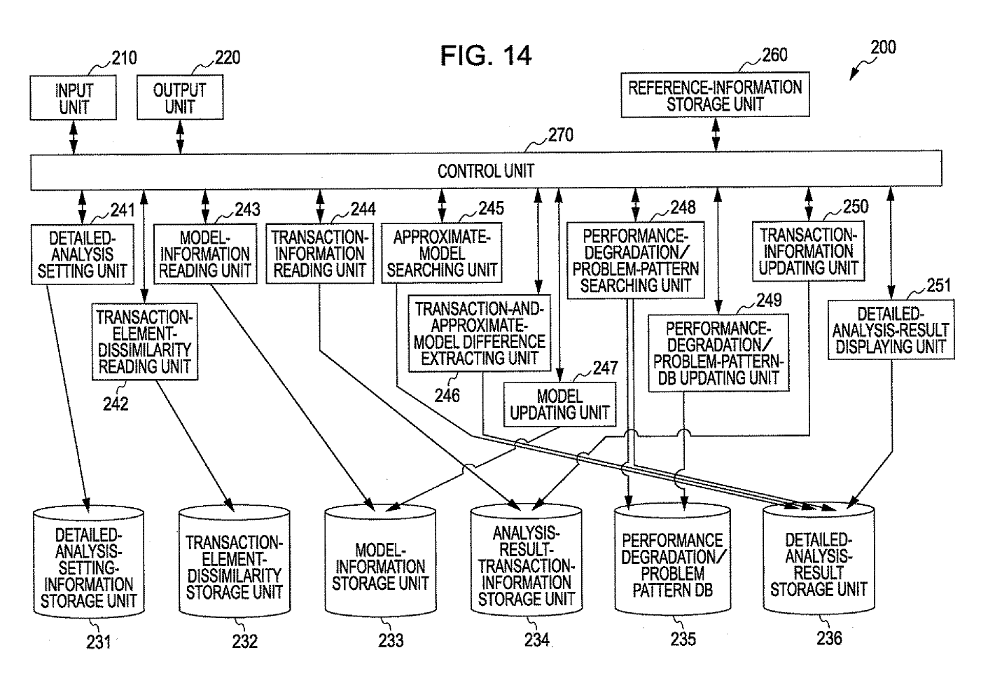

Next, a configuration of the transaction detail analyzing apparatus is described. FIG. 14 is a block diagram showing a functional configuration of a transaction detail analyzing apparatus. As shown in FIG. 14, a transaction detail analyzing apparatus 200 includes an input unit 210, an output unit 220, a detailed-analysis-setting-information storage unit 231, a transaction-element-dissimilarity storage unit 232, a model-information storage unit 233, an analysis-result-transaction-information storage unit 234, a performance degradation/problem pattern DB 235, a detailed-analysis-result storage unit 236. The transaction detail analyzing apparatus includes a detailed-analysis-setting unit 241, a transaction-element-dissimilarity reading unit 242, a model-information reading unit 243, a transaction-information reading unit 244, an approximate-model searching unit 245, a transaction-and-approximate-model difference extracting unit 246, a model updating unit 247, a performance-degradation/problem-pattern searching unit 248, a performance-degradation/problem-pattern-DB updating unit 249, a transaction-information updating unit 250, a detailed-analysis-result displaying unit 251, a reference-information storage unit 260, and a controlling unit 270.

The input unit 210 is a processing unit that accepts (receives) instruction(s) regarding result(s) of detailed analysis, or the like, from a system administrator. More specifically, the input unit 210 accepts instructions issued by the system administrator using an input device, such as a mouse or a keyboard. The output unit 220 is a processing unit that outputs result(s) of analysis by the transaction detail analyzing apparatus 200. For example, the output unit 220 displays results of analysis of transactions on a display.

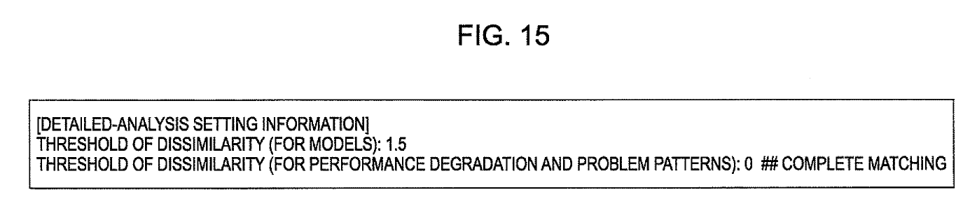

The detailed-analysis-setting-information storage unit 231 is a storage unit that stores setting information regarding detailed analysis as detailed-analysis setting information. FIG. 15 is a diagram showing an example of detailed-analysis setting information stored in the detailed-analysis-setting-information storage unit 231. As shown in FIG. 15, the detailed-analysis-setting-information storage unit 231 stores a dissimilarity threshold for model(s) and a dissimilarity threshold for performance degradation/problem pattern(s) as detailed-analysis setting information.

The dissimilarity threshold for model(s) is a threshold that is used to search for a transaction model that is approximate to a transaction. If there exists no transaction model having a dissimilarity within this threshold, no approximate model is returned by searching. The dissimilarity threshold for performance degradation/problem pattern(s) is used to search for a performance degradation/problem pattern that is approximate to the transaction. If there exists no performance degradation/problem pattern having a dissimilarity within this threshold, no performance degradation/problem pattern is returned by searching. In FIG. 15, the dissimilarity threshold for performance degradation/problem patterns is chosen to be “0”, so that only performance degradation/problem pattern(s) exactly matching transaction(s) are returned by searching.

The transaction-element-dissimilarity storage unit 232 is a storage unit that stores dissimilarities between pairs of transaction elements as transaction element dissimilarities, similarly to the transaction-element dissimilarity storage unit 134. The model-information storage unit 233 is a storage unit that stores information of transaction models as model information, similar to the model-information storage unit 133.

The analysis-result-transaction-information storage unit 234 is a storage unit that stores result(s) of analysis of transaction(s) as analysis-result transaction information, similar to the analysis-result-transaction-information storage unit 135. Furthermore, the analysis-result-transaction-information storage unit 234 also stores information regarding approximate model(s) and background information.

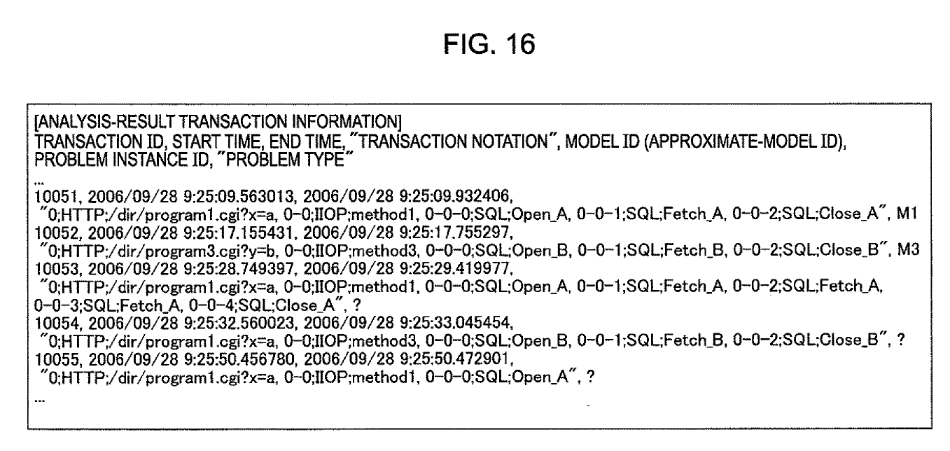

FIG. 16 is a diagram showing an example of analysis-result transaction information stored in the analysis-result-transaction-information storage unit 234. As shown in FIG. 16, for each transaction in the analysis-result transaction information, the analysis-result-transaction-information storage unit 234 stores a transaction ID, a start time and an end time, and a “transaction notation”, and also stores a model ID of an approximate model, a problem instance ID, and a “problem type”. The model ID of the approximate model is stored with enclosing parentheses. The problem instance ID is an ID of a performance degradation/problem pattern matching the transaction, and the “problem type” is information indicating a problem type, such as “DB problem” or “APL problem”.

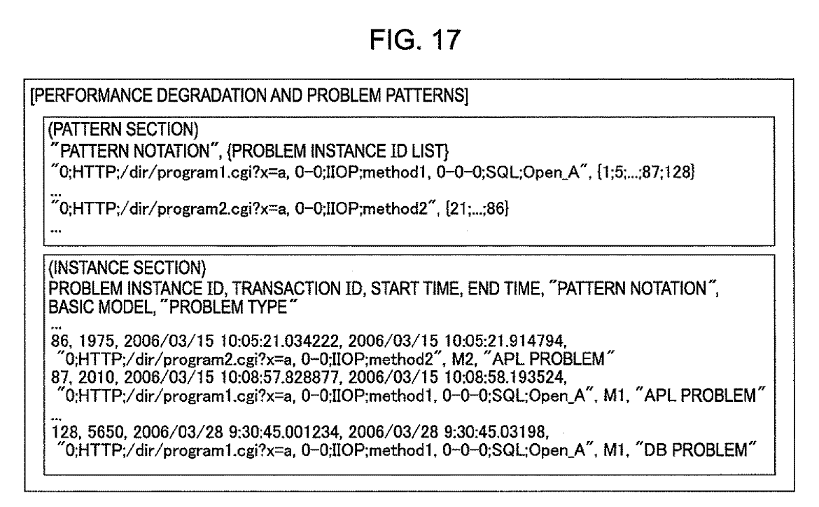

The performance degradation/problem pattern DB 235 is a database that stores information of abnormal transactions that occurred in the past as performance degradation/problem patterns together with background information. FIG. 17 is a diagram showing an example of information regarding performance degradation/problem pattern(s) stored in the performance degradation/problem pattern DB 235. As shown in FIG. 17, the performance degradation/problem pattern DB 235 stores information of each performance degradation/problem pattern divided (independent) in a pattern section and an instance section.

The pattern section is a storage area that stores the “transaction notation” of an abnormal transaction that occurred in the past as a “pattern notation” and that stores a list of IDs of corresponding instance(s) as a problem instance ID list for each “pattern notation”. The instance section stores information of an abnormal transaction that occurred in the past, together with background information. More specifically, the instance section is a storage area that stores a problem instance ID identifying a problem instance, a transaction ID, a start time and an end time, a “pattern notation”, a basic model, and a “problem type”. The basic model refers to a model ID of a most approximate transaction model.

The detailed-analysis-result storage unit 236 is a storage unit that stores result(s) of detailed analysis of transaction(s). For example, the detailed-analysis-result storage unit 236 stores a “transaction notation”, a model ID of an approximate model, information regarding a difference with the approximate model, and background information.

The detailed-analysis-setting unit 241 is a processing unit that reads detailed-analysis setting information from the detailed-analysis-setting-information storage unit 231 and writes the detailed-analysis setting information to the reference-information storage unit 260. The transaction-element-dissimilarity reading unit 242 is a processing unit that reads transaction element dissimilarities from the transaction-element-dissimilarity storage unit 232 and writes the transaction element dissimilarities to the reference-information storage unit 260.

The model-information reading unit 243 is a processing unit that reads model information from the model-information storage unit 233 and writes the model information to the reference-information storage unit 260. The transaction-information reading unit 244 is a processing unit that reads information of transaction(s) not matching any transaction model from the analysis-result-transaction-information storage unit 234 and writes the information to the reference-information storage unit 260.

The approximate-model searching unit 245 is a processing unit that searches the reference-information storage unit 260 for a transaction model that is approximate to a transaction not matching any transaction model, and writes a result of searching to the detailed-analysis-result storage unit 236 together with information of the transaction. If there exists no transaction model having a dissimilarity within the dissimilarity threshold for models, the approximate-model searching unit 245 returns no approximate model as a result of the searching.

The transaction-and-approximate-model difference extracting unit 246 is a processing unit that compares a transaction with an approximate model to extract differences. The transaction-and-approximate-model difference extracting unit 246 extracts different part(s), missing part(s), and extra part(s) by comparison with the approximate model, and writes the results of extraction to the detailed-analysis-result storage unit 236.

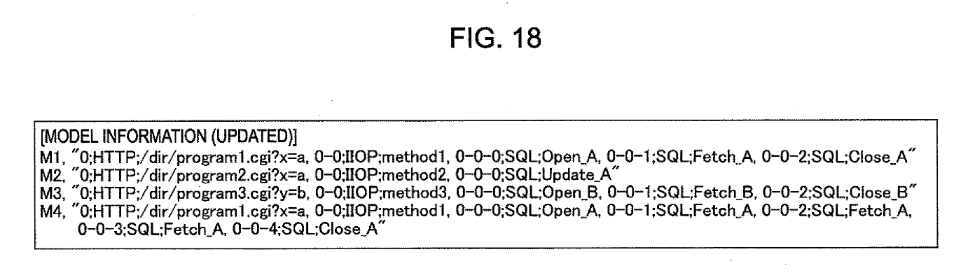

The model updating unit 247 is a processing unit that registers a transaction as a new transaction model to the model-information storage unit 233 when an instruction to add the transaction as a model is input by the system administrator. FIG. 18 is a diagram showing an example of updating of the model information shown in FIG. 6. As shown in FIG. 18, in this example of updated model information, “M4” has been newly added as a transaction model.

The performance-degradation/problem-pattern searching unit 248 is a processing unit that searches the performance degradation/problem pattern DB 235 for a performance degradation/problem pattern and writes a result of searching to the detailed-analysis-result storage unit 236.

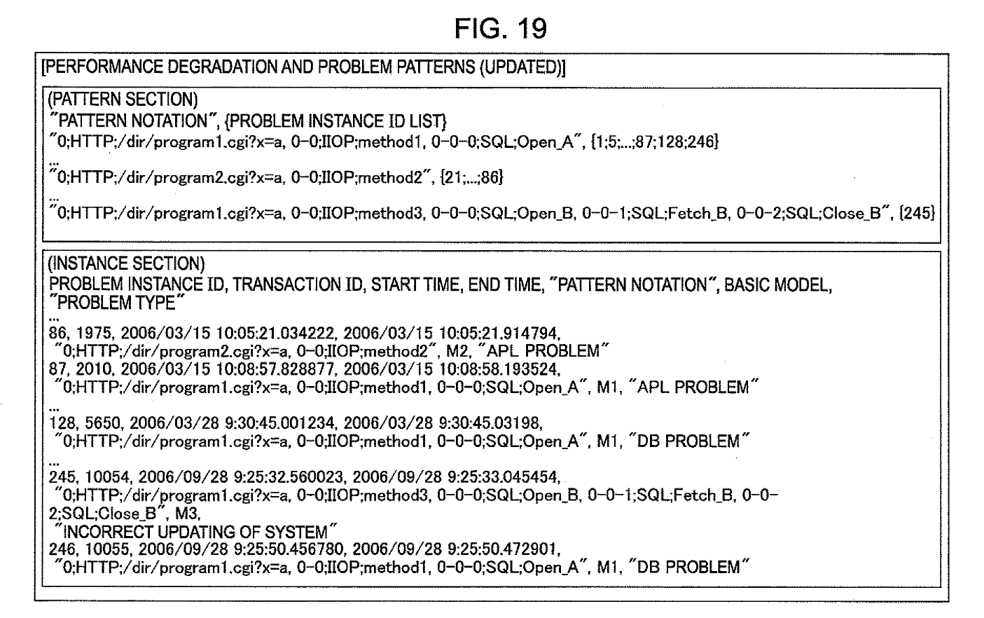

The performance degradation/problem pattern DB updating unit 249 is a processing unit that registers a transaction as a new problem instance in the performance degradation/problem pattern DB 235 when an input indicating that the system administrator has determined that the transaction is abnormal is accepted. FIG. 19 is a diagram showing an example of updating of a performance degradation/problem pattern shown in FIG. 17. As shown in FIG. 19, in the example of an updated performance degradation/problem pattern, problem instances with problem instance IDs of “245” and “246” have been newly added.

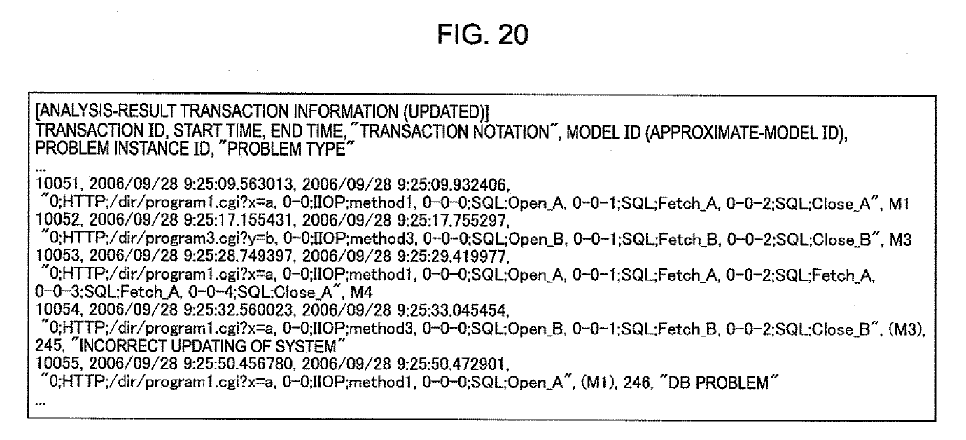

The transaction-information updating unit 250 is a processing unit that updates analysis-result transaction information in the analysis-result-transaction-information storage unit 234 on the basis of result(s) of detailed analysis. FIG. 20 is a diagram showing an example of updating of the analysis-result transaction information shown in FIG. 16. As shown in FIG. 20, in the example of updated analysis-result transaction information, regarding transaction(s) not matching any transaction model, a new model ID “M4”, approximate-model IDs “(M3)” and “(M1)”, problem instance IDs “245” and “246”, and problem types “incorrect updating of system” and “DB problem” have been added.

The detailed-analysis-result displaying unit 251 is a processing unit that displays result(s) of detailed analysis stored in the detailed-analysis-result storage unit 236 via the output unit 220. The system administrator is thus assisted in finding a cause of mismatch between transactions and transaction model(s) on the basis of result(s) of detailed analysis displayed by the detailed-analysis-result displaying unit 251.

The reference-information storage unit 260 stores detailed-analysis setting information, transaction element dissimilarities, model information, and transaction information read by the detailed-analysis-setting unit 241, the transaction-element-dissimilarity reading unit 242, the model-information reading unit 243, and the transaction-information reading unit 244, respectively. The information stored in the reference-information storage unit 260 is referred to by the approximate-model searching unit 245, the transaction-and-approximate-model difference extracting unit 246, the performance-degradation/problem-pattern searching unit 248, and so forth.

The controlling unit 270 controls the input unit 210, the output unit 220, the detailed-analysis-setting unit 241, the transaction-element-dissimilarity reading unit 242, the model-information reading unit 243, the transaction-information reading unit 244, the approximate-model searching unit 245, the transaction-and-approximate-model difference extracting unit 246, the model updating unit 247, the performance-degradation/problem-pattern searching unit 248, the performance-degradation/problem-pattern-DB updating unit 249, the transaction-information updating unit 250, and the detailed-analysis-result displaying unit 251 described above so that the transaction detail analyzing apparatus 200 functions as one apparatus. In FIG. 14, one or more storage unit(s) may be provided in a magnetic disk device, and arrows between the storage unit(s) and processing unit(s) represent accesses from the processing units to the storage units.

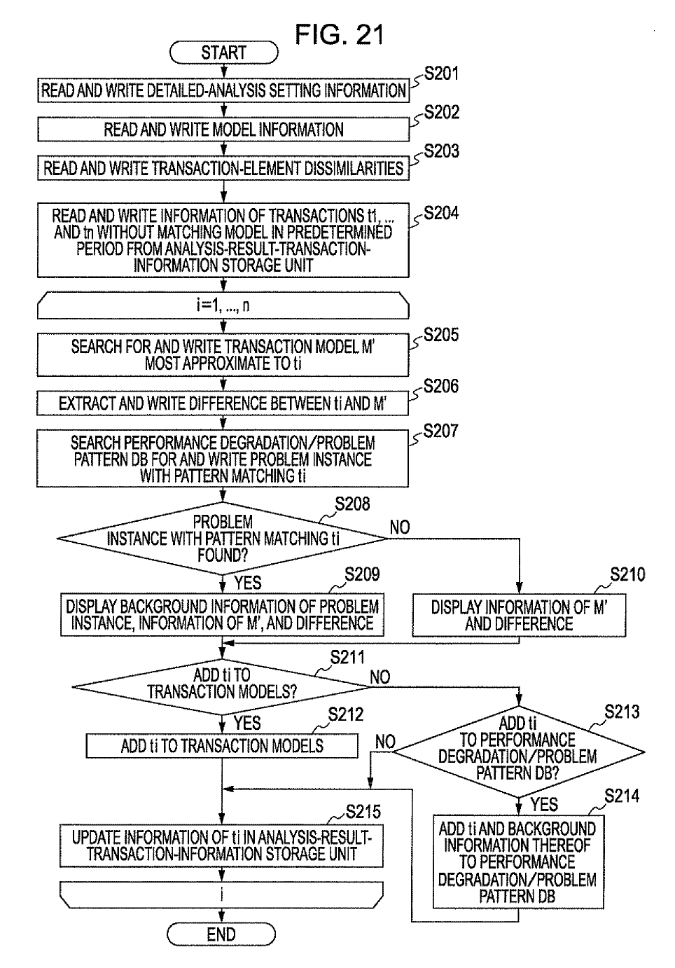

Next, a procedure of a transaction detail analyzing process executed by the transaction detail analyzing apparatus 200 according to an embodiment is described. FIG. 21 is a flowchart showing a procedure of a transaction detail analyzing process executed by the transaction detail analyzing apparatus 200 according to this embodiment.

As shown in FIG. 21, in the transaction detail analyzing process, the detailed-analysis-setting unit 241 reads detailed-analysis setting information and writes the detailed-analysis setting information to the reference-information storage unit 260 (operation S201). Furthermore, the model-information reading unit 243 reads model information and writes the model information to the reference-information storage unit 260 (operation S202). Furthermore, the transaction-element-dissimilarity reading unit 242 reads transaction element dissimilarities and writes the transaction element dissimilarities to the reference-information storage unit 260 (operation S203).

Then, the transaction-information reading unit 244 reads transaction information of transactions not matching any transaction model in a predetermined period, i.e., information of transactions t1, . . . and tn not matching any transaction model, and writes the transaction information to the reference-information storage unit 260 (operation S204). Then, the controlling unit 270 exercises control to execute operations S205 to S213 for information ti of each of the transactions.

More specifically, the approximate-model searching unit 245 reads ti from the reference-information storage unit 260, searches for a transaction model M′ most approximate to ti, and writes M′ as information of an approximate model to the detailed-analysis-result storage unit 236 together with ti (operation S205). Then, the transaction-and-approximate-model difference extracting unit 246 extracts difference(s) between ti and M′, and writes information of the differences to the detailed-analysis-result storage unit 236 (operation S206). Then, the performance-degradation/problem-pattern searching unit 248 searches the performance degradation/problem pattern DB 235 for a problem instance having a pattern matching ti, and writes a result of searching to the detailed-analysis-result storage unit 236 (operation S207).

Then, the detailed-analysis-result displaying unit 251 checks whether there exists any problem instance having a pattern matching ti (operation S208). If a matching problem instance is found, the detailed-analysis-result displaying unit 251 displays background information, information of M′, and difference(s) (operation S209). If no matching problem instance is found, the detailed-analysis-result displaying unit 251 displays the information of M′ and difference(s) (operation S210).

Then, the model updating unit 247 accepts (receives) an instruction from a system administrator as to whether ti is to be added to the transaction models (operation S211). If an instruction to add is accepted, the model updating unit 247 adds ti to update the transaction models in the model-information storage unit 233 (operation S212).

On the other hand, if an instruction not to add is accepted, the performance degradation/problem pattern DB updating unit 249 accepts an instruction from the system administrator as to whether ti is to be added to the performance degradation/problem pattern DB 235 (operation S213). If an instruction to add is accepted, the performance degradation/problem pattern DB updating unit 249 adds ti to the performance degradation/problem pattern DB 235 together with background information (operation S214).

On the other hand, if at operation S113, an instruction to add is not accepted, the process proceeds to operation S115. Then, the transaction-information updating unit 250 updates information of ti in the analysis-result-transaction-information storage unit 234 (operation S215).

As described above, the transaction detail analyzing apparatus 200 analyzes in detail transactions not matching any transaction model and displays results of the analysis. This assists in aiding analysis of abnormalities by a system administrator.

Although the detailed-analysis-result displaying unit 251 displays background information obtained by searching the performance degradation/problem pattern DB 235 on a basis of individual problem instances in this embodiment, alternatively, background information may be grouped on the basis of basic models or problem types and displayed on a group-by-group basis.

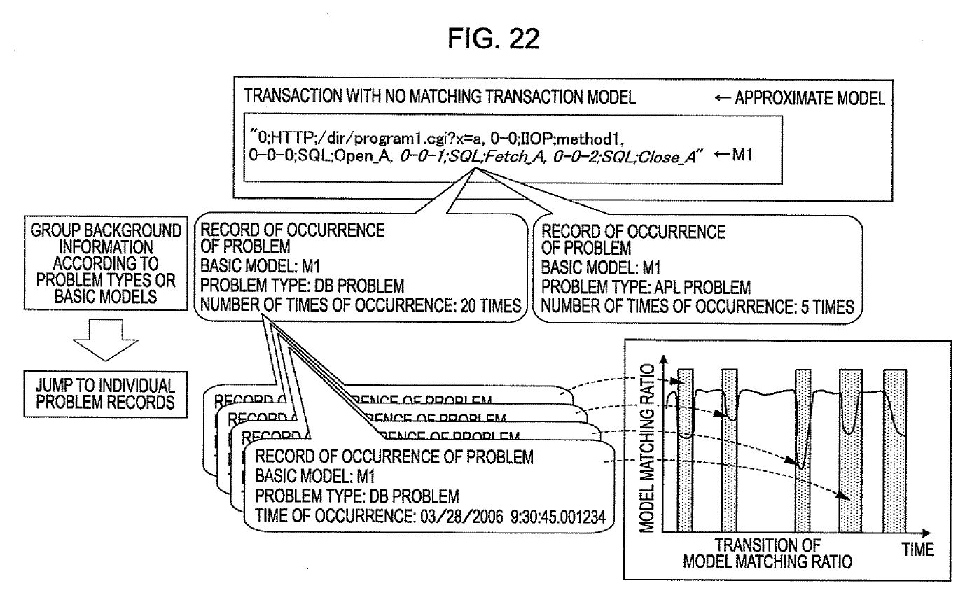

FIG. 22 is a diagram showing an example where problem record(s) are displayed on a group-by-group basis. In the example shown in FIG. 22, background information is grouped on the basis of individual problem types, and a number of times of occurrence of each of the problem types is displayed as part of the background information. The records of individual problem instances are displayed when the system administrator instructs display of or requests detailed information.

In the example shown in FIG. 22, according to an instruction from the system administrator, the transaction detail analyzing apparatus displays transition of model matching ratio from a time of a first occurrence to a time of a latest occurrence of instances of the same problem type in the past. By displaying the transition of model matching ratio in a case where problems occurred, the transaction detail analyzing apparatus can aid problem analysis by the system administrator.

As described above, according to this embodiment, the transaction monitoring apparatus 100 monitors transactions on the basis of transaction models, and the transaction detail analyzing apparatus 200 is instructed to analyze in detail transactions not matching any transaction model if the model matching ratio is less than a predetermined threshold. This can aid system analysis by a system administrator.

More specifically, for each transaction not matching any transaction model, the approximate-model searching unit 245 of the transaction detail analyzing apparatus 200 searches for a most approximate model, the transaction-and-approximate-model difference extracting unit 246 extracts differences from the approximate model, and the detailed-analysis-result displaying unit 251 displays a difference(s) in a highlighted manner. Thus, the system administrator can readily determine whether the transaction is abnormal or not. Furthermore, the model updating unit 247 additionally registers each transaction determined by the system administrator as not abnormal (normal) as a new transaction model. Thus, the transaction monitoring apparatus 100 can operate in accordance with updating of the system or change in usage patterns of the system.

The performance-degradation/problem-pattern searching unit 248 searches the performance degradation/problem pattern DB 235 for past problem instances of the same problem type and displays background information of the problem instance. Thus, the system administrator can analyze an abnormality of the system using information of the past problem instance of the same problem type.

That is, with the output from the apparatus according to the embodiment described above, the system administrator can efficiently obtain past information regarding an occurrence of problem(s) in a system. Thus, advantageously, the system administrator can efficiently analyze a processing status of the system.

Furthermore, the performance degradation/problem pattern DB updating unit 249 additionally registers each transaction determined as a problem by the system administrator as a problem instance in the performance degradation/problem pattern DB 235. Thus, information of problem instances can be accumulated in a database and used for problem analysis.

Furthermore, in the apparatus according to an embodiment, transaction models are updated in accordance with updating of the system or change in usage patterns of the system. Thus, advantageously, the load of the system administrator to update transaction models can be alleviated.

In an embodiment, the system administrator determines whether to update transaction models on the basis of result(s) of detailed analysis displayed by the detailed-analysis-result displaying unit 251, and issues an instruction to the transaction detail analyzing apparatus 200. Alternatively, the transaction detail analyzing apparatus 200 may be configured to automatically determine whether to update transaction model(s).

For example, the transaction detail analyzing apparatus 200 may be configured to determine that a transaction not matching any transaction models is “normal” and to automatically add the transaction to transaction models if a number of difference(s) is the same as a number of “Fetch” commands in SQL statements. Alternatively, the transaction detail analyzing apparatus 200 may be configured to determine that a transaction not matching any transaction model(s) is “normal” and to automatically add the transaction to transaction models if a difference in the number of “Fetch” commands is within “3” while leaving the determination to the system administrator if the difference exceeds “3”. By automatically updating transaction models, the transaction detail analyzing apparatus can reduce the load of the system administrator.

Although the transaction monitoring apparatus and the transaction detail analyzing apparatus have been described above, a configuration of the transaction monitoring apparatus or the transaction detail analyzing apparatus can be implemented in software to provide a transaction monitoring program or a transaction detail analyzing program having similar functions. Now, a computer for executing these programs is described.

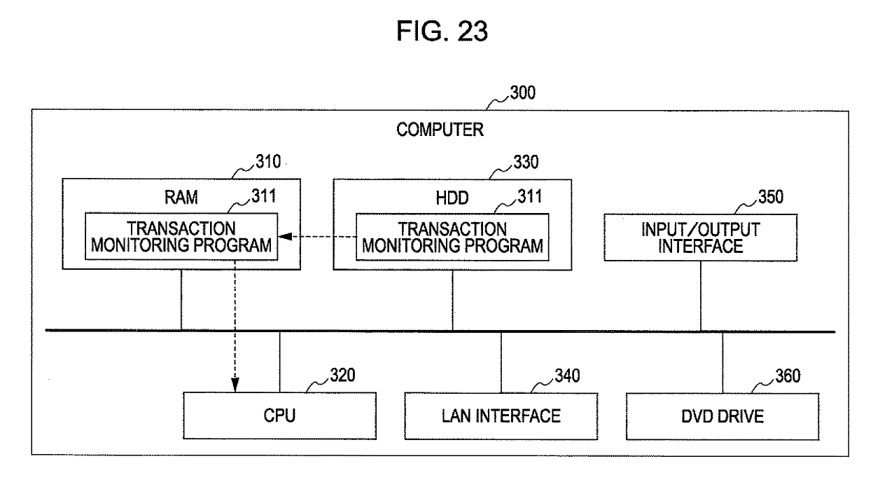

FIG. 23 is a functional block diagram of a computer for executing a transaction monitoring program according to an embodiment. A transaction detail analyzing program can also be executed by a computer having a similar configuration. As shown in FIG. 23, a computer 300 includes a random access memory (RAM) 310, a central processing unit (CPU) 320, a hard disk drive (HDD) 330, a local area network (LAN) interface 340, an input/output interface 350, and a digital versatile disc (DVD) drive 360.

The RAM 310 is a memory that stores program(s) or result(s) of processing in the course of execution of program(s). The CPU 320 reads program(s) from the RAM 310 and executes the program(s). The HDD 330 is a disk device that stores program(s) and data. The LAN interface 340 is an interface that serves to connect the computer 300 with another computer via a LAN. The input/output interface 350 is an interface connecting an input device, such as a mouse or a keyboard, and a display. The DVD drive 360 is a device that reads data from or writes data to a DVD.

A transaction monitoring program 311 executed by the computer 300 is stored on a DVD, read from the DVD by the DVD drive 360, and installed on the computer 300. Alternatively, the transaction monitoring program 311 is stored in a database or the like of another computer system connected via the LAN interface 340, read from the database, and installed on the computer 300. Then, the installed transaction monitoring program 311 is stored in the HDD 330, read by the RAM 310, and executed by the CPU 320.

Furthermore, although the embodiment has been described in the context of monitoring and analysis of transactions, without limitation to the embodiment, the present invention can be applied similarly to computer system(s) that process(es) unit process(es) similar to transaction(s).

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A computer-readable storage medium storing a program for causing a computer to operate as a system monitoring apparatus that monitors a system in which a plurality of types of unit processes are executed, the program causing the computer to execute operations, comprising:
determining whether each unit process executed by the system matches one of a plurality of unit process models generated by individually modeling the plurality of types of unit processes;
determining, based on a result of said determining whether each unit process matches one of said plurality of unit process models, whether an analysis of a processing status of the system is needed; and
displaying, when determining that the analysis of the processing status of the system is needed, a difference of a most approximate unit process model among the plurality of unit process models in relation to each unit process determined as matching none of the plurality of unit process models.

2. The storage medium according to claim 1, wherein a problem-information database in which each unit process indicating a problem of the system is stored in association with problem information is searched using each unit process determined as matching none of the plurality of unit process models, and if any corresponding unit process is found by the searching, problem information associated with the unit process found by the searching is displayed.

3. The storage medium according to claim 1, wherein unit processes determined as matching none of the plurality of unit process models are grouped based on unit process models that are most approximate to the unit processes among the plurality of unit process models, and problem information is displayed on a group-by-group basis.

4. The storage medium according to claim 1, comprising:
executing a model updating procedure of accepting determination by a system administrator as to whether each unit process analyzed is normal or not, or a model updating procedure of determining as to whether each unit process analyzed is normal or not based on the difference, and adding the unit process as a new unit process model if a determination that the unit process is normal is accepted or determined.

5. A computer-readable storage medium storing a system analyzing program for causing a computer to operate as an apparatus that analyses a system in which a plurality of types of unit processes is executed, the program causing the computer to execute operations, comprising:
searching for a most approximate unit process model for each new unit process, a new unit process being a unit process matching none of a plurality of unit process models generated by individually modeling the plurality of types of unit processes;
extracting a difference between the approximate unit process model found by the searching and the new unit process; and
displaying information of the new unit process in such a manner that the difference extracted is highlighted.

6. A system monitoring method for a system monitoring apparatus that monitors a system in which a plurality of types of unit processes are executed, the system monitoring method comprising:
determining whether each unit process executed by the system matches one of a plurality of unit process models generated by individually modeling the plurality of types of unit processes;
determining, based on a result of said determining whether each unit process matches one of said plurality of unit models, whether an analysis of a processing status of the system is needed; and
displaying, when determining that the analysis of the processing status of the system is needed, a difference of a most approximate unit process model among the plurality of unit process models in relation to each unit process determined as matching none of the plurality of unit process models.

7. The system monitoring method according to claim 6, wherein, a problem-information database in which each unit process indicating a problem of the system is stored in association with problem information is searched using each unit process determined as matching none of the plurality of unit process models, and if any corresponding unit process is found by the searching, problem information associated with the unit process found by the searching is displayed.

8. The system monitoring method according to claim 6, wherein unit processes determined as matching none of the plurality of unit process models are grouped based on unit process models that are most approximate to the unit processes among the plurality of unit process models, and problem information is displayed on a group-by-group basis.

9. The system monitoring method according to claim 6 comprising:
executing a model updating operation of accepting determination by a system administrator as to whether each unit process analyzed is normal or not, or a model updating operation of determining as to whether each unit process analyzed is normal or not based on the difference, and adding the unit process as a new unit process model if a determination that the unit process is normal is accepted or determined.

10. A system analyzing method for a system analyzing apparatus that analyses a system in which a plurality of types of unit processes is executed, the system analyzing method comprising:
searching for a most approximate unit process model for each new unit process, a new unit process being a unit process matching none of a plurality of unit process models generated by individually modeling the plurality of types of unit processes;
extracting a difference between the approximate unit process model found by the searching and the new unit process; and
displaying information of the new unit process in such a manner that the difference extracted in the difference extracting is highlighted.

11. A system monitoring apparatus that monitors a system in which a plurality of types of unit processes are executed, the system monitoring apparatus comprising:
unit-process determining means for determining whether each unit process executed by the system matches one of a plurality of unit process models generated by individually modeling the plurality of types of unit processes;
need-for-analysis determining means for determining, based on a result of determination by the unit-process determining means, whether an analysis of a processing status of the system is needed; and
analysis executing means for displaying, when determined by the need-for-analysis determining means that the analysis of the processing status of the system is needed, a difference of a most approximate unit process model among the plurality of unit process models in relation to each unit process determined by the unit-process determining means as matching none of the plurality of unit process models.

12. The system monitoring apparatus according to claim 11, wherein the analysis executing means searches a problem-information database in which each unit process indicating a problem of the system is stored in association with problem information, using each unit process determined by the unit-process determining means as matching none of the plurality of unit process models, and if any corresponding unit process is found by the searching, the analysis executing means further displays problem information associated with the unit process found by the searching.

13. The system monitoring apparatus according to claim 11, wherein the analysis executing means groups unit processes determined as matching none of the plurality of unit process models by the unit-process determining means, based on unit process models that are most approximate to the unit processes among the plurality of unit process models, and displays problem information on a group-by-group basis.

14. The system monitoring apparatus according to claim 11 comprising:
model updating means for accepting determination by a system administrator as to whether each unit process analyzed in the analysis executing operation is normal or not, or for determining as to whether each unit process analyzed in the analysis executing operation is normal or not based on the difference, and adding the unit process as a new unit process model if a determination that the unit process is normal is accepted or determined.

15. A system analyzing apparatus that analyses a system in which a plurality of types of unit processes is executed, the system analyzing apparatus comprising:
approximate-model searching means for searching for a most approximate unit process model for each new unit process, a new unit process being a unit process matching none of a plurality of unit process models generated by individually modeling the plurality of types of unit processes;
difference extracting means for extracting a difference between the approximate unit process model found by the searching by the approximate-model searching means and the new unit process; and
highlight displaying means for displaying information of the new unit process in such a manner that the difference extracted by the difference extracting means is highlighted.
